(19) United States
(12) Patent Application Publication
(10) Pub. No.: US 2009/0252844 A1
(43) Pub. Date: Oct. 8, 2009

(54) HIGH FIBER PASTA

(75) Inventor: David C. Skinner, Valle Crucis, NC (US)

Correspondence Address: JAMES F. HARRINGTON, ESQ.;HOFFMANN & BARON, LLP, 6900 Jericho Turnpike, Syossef, NY, 11791, US

(73) Assignee: Amish Naturals, Inc., Holmesville, OH (US)

(21) Appl. No.: 12/417,047

(22) Filed: Apr. 2, 2009

Related U.S. Application Data
(60) Provisional application No. 61/041,743, filed on Apr. 2, 2008.

(51) Int. Cl. A23L 1/16; A23P 1/02

(52) U.S. Cl. 426/285; 426/557

(57) ABSTRACT

A high fiber pasta and its method of manufacture are provided. The method includes the formation of a partially reconstituted high fiber wheat flour component (HFWFC), which includes dry combining a low-moisture-content fiber source (LMFS) into the host/carrier in an amount which provides a substantially homogenous mixture throughout the host/carrier, and dry blending into the homogeneous mixture at least one grain-based binder and a grain-based texturizer each having a moisture content greater than the LMFS.

### CROSS REFERENCE TO RELATED APPLICATIONS

The present application claims priority to U.S. Provisional Application No. 61/041,743 filed on Apr. 2, 2008, the entirety of which is incorporated herein by reference.

### BACKGROUND OF THE INVENTION

The present invention relates to pasta products and, in particular, to pasta having a high fiber content.

The USDA recommends that Americans eat a diet high in fiber and low in fat. The benefits of a high fiber diet are numerous and include reduced risk of heart disease and stroke, reduced risk of large bowel cancer, reduction in cholesterol, a moderation of blood sugar levels, and aid in weight loss.

According to the USDA, the Institute of Medicine recommends 19-38 grams of fiber per day, depending on age and gender, with at least three daily servings of whole-grain foods. However, according to the USDA, the average American consumes only 14 grams of dietary fiber per day. Thus, there is a need for foods that have a higher fiber content, to permit people to increase their fiber intake.

In view of the foregoing, an increasing number of high fiber foods and supplements are being created. However, the flour based food products conventionally prepared that have the desired nutritional criteria do not include a satisfactory amount of fiber.

In an effort to increase fiber content, attempts have been made to blend fiber into the flour of flour-based products. Many high fiber blends restrict volume and do not provide proper absorption. This can give flour-based comestibles a “heavy” or “dense” texture and taste. In addition, many of the high fiber flour based blends currently available have an unpleasant taste caused by the fiber supplements.

U.S. Pat. No. 4,976,982 discloses a reduced calorie, high fiber pasta. The process for making the pasta includes adding a reducing agent, preferably a sulfur-containing chemical, to treat the added fiber and assist in its incorporation into the pasta flour. However, such reducing agents can cause the taste and smell of the pasta to be off. In addition, consumers prefer to eat foods that are all natural, without added chemical agents.

U.S. Pat. No. 5,258,195 discloses a pasta product and method of manufacture. The process includes the preparation of a pasta product by incorporating glutinous flour, Jerusalem artichoke flour, and water. The '195 patent explains that water is required to incorporate the necessary ingredients. Thus, the fiber component cannot be added to the flour mixture until the pasta is ready to be made.

Thus, there remains a need to for a high fiber pasta that is all natural and which incorporates the desired fiber. There is also a need for a high fiber pasta that has a natural taste and mouthfeel and avoids the unwanted organoleptic shortcomings normally associated with conventional high fiber pasta products.

### SUMMARY OF THE INVENTION

The present invention includes an all natural high fiber pasta and a method of preparing the same.

The method includes the steps: a) dry functionalizing a flour-based host/carrier to exude endogenous moisture, b) semi-sequentially dry combining (SSDC) a low-moisture-content fiber source (LMFS) with the host/carrier in an amount which provides a substantially homogenous mixture throughout the host/carrier, and c) dry blending at least one grain-based binder and a grain-based texturizer into the homogeneous mixture to form a partially reconstituted high fiber wheat flour component (HFWFC), the grain-based binder and grain-based texturizer each having a moisture content greater than that of the LMFS.

The HFWFC resulting from steps a) through c) can then be mixed with a suitable pasta flour and a liquid to form a dough. The dough can then be processed to form a high fiber pasta. Preferably, the pasta flour and HFWFC are pre-mixed, for example by sifting together, before the liquid is added.

In a preferred embodiment, the texturizer is modified wheat starch. Preferably, the texturizer has a moisture content that is greater than that of the LMFS and the binder, but less than that of the host/carrier.

In another preferred embodiment, the method further includes an additional step of subjecting the HFWFC resulting from steps a) through c) to sifting to regularize particles size of the dry mixture. In another preferred embodiment, the method further includes agglomerizing the sifted HFWFC based on the binding characteristic of the moisture exudate of the dry ingredients to provide particle aggregates of substantially uniform size and flow characteristics.

Various flavors can be added to the dry mixture HFWFC. Preferably the flavors are added during the sifting step.

In a preferred embodiment, the host/carrier is a wheat-based flour having a moisture content of from about 10% to about 14%. The wheat based flour can be, for example, durum wheat having a moisture content of from about 12% to about 14% or whole wheat having moisture content of from about 10% to about 13%.

In a preferred embodiment, the LMFS is a vegetable fiber having a moisture content of less than about 6% and a dietary fiber content of greater than about 80%. The LMFS can be any edible high fiber ingredient. Preferably, the vegetable fiber is one that includes inulin, such as Jerusalem artichoke.

The LMFS can be added in any amount suitable to give the desired fiber characteristics. For example, the LMFS can be added in an amount of about 4 wt % to about 16 wt % of the HFWFC.

The at least one grain-based binder can be selected, for example, from the group consisting of wheat protein, wheat gluten, and a combination thereof. The binder can include, for example, wheat protein and/or wheat gluten added in an amount of from about 3 wt % to about 12 wt % of the HFWFC.

One embodiment contemplates that the at least one binder include wheat protein or wheat gluten added in an amount of from about 3 wt % to about 12 wt % of the HFWFC, and a texturizer that includes modified wheat starch added in an amount of from about 20 wt % to about 50 wt % of the HFWFC.

In another aspect of the invention, a high fiber pasta is provided. The high fiber pasta includes a HFWFC manufactured by the steps outlined above.

In another aspect of the invention, a high fiber pasta is provided that includes a) a flour-based host/carrier, wherein said host/carrier has been functionalized to exude endogenous moisture, b) a low-moisture-content fiber source (LMFS) that has been semi-sequentially dry combined (SSDC) with said host/carrier in an amount which provides a substantially homogenous mixture throughout said host/carrier, and c) at least one grain-based binder and a grain-based texturizer that have been dry blended into said homogeneous mixture to form a partially reconstituted high fiber wheat flour component (HFWFC), the grain-based binder and grain-based texturizer each having a moisture content greater than that of the LMFS.

The high fiber pasta of the invention and methods of manufacture thereof satisfy the need to increase the fiber content of pasta without incurring the unwanted organoleptic shortcomings normally associated with high fiber pasta. As discussed above, high fiber foods, especially flour based foods such as pasta, traditionally have a heavy feel and are often grainy.

The pasta of the invention made using the HFWFC provides a natural lightness and al dente mouthfeel, without the traditional toughness and graniness typically present in high fiber pastas.

The inventor has discovered an additional advantage of utilizing the HFWFC to form the high fiber pasta of the invention. In blending the ingredients to form high fiber pasta, durum wheat can be used instead of semolina. This produces a pasta with improved taste, mouthfeel and nutrient profile compared to conventional high fiber pasta products.

In addition, the inventor has discovered that the addition of flavors, especially seasonings such as garlic, etc., during sifting enhances the intensity and sustains the potency of the seasoning from manufacturing to use by a consumer.

### DETAILED DESCRIPTION OF THE INVENTION

The present invention provides a method of preparing an all natural high fiber pasta and its method of manufacture.

“All natural” as defined herein means that only products from nature or derived from nature are used in the methods and products of the invention. Examples include wheat and wheat-based ingredients, such as wheat flour, wheat gluten, wheat protein and wheat starch. Additional examples include vegetable fiber and natural flavorings. Synthetic ingredients or those that are chemically manufactured are preferably not employed.

“Flour” as defined herein means the glutinous and/or starchy powder obtained from the milling of grains or other vegetable matter, as described above. Grain, i.e., the grass fruit, includes the endosperm, which is the starchy part, the germ, which is the proteinaceous part, and the bran or fiber part. Different types of flour include different percentages of starch and protein. However, naturally made white flour contains only a relatively small amount of fiber, e.g., about 0.1-1%.

High fiber means a pasta having a higher dietary fiber content than is conventionally found in pasta. Conventional pasta will typically have a dietary fiber content of about 2 grams per 2 oz. serving. For example, the pasta of the invention can have a dietary fiber content of at least 5 grams, preferably 10 grams, more preferably at least 15 grams, most preferably at least 20 grams per 57 gram (2 oz.) serving.

The method first includes preparing a partially reconstituted high fiber wheat flour component (HFWFC). The formation of the HFWFC includes dry functionalizing (DF) a flour-based host/carrier to exude endogenous moisture, dry combining a low-moisture-content fiber source (LMFS) into the host/carrier in an amount which provides a substantially homogenous mixture throughout the host/carrier, and dry blending into the homogeneous mixture at least one grain-based binder having a moisture content greater than the LMFS.

“Dry functionalizing” as defined herein means disrupting the structure of a host/carrier, e.g., by mechanical mixing, sufficient to free the moisture in the host/carrier so that it exudes and acts as a mixing aid, e.g., surfactant. Dry functionalizing in the invention process means that no added water is used to affect hydration sufficient to provide a homogenous mixture between a host/carrier and a low-moisture fiber source.

A “host/carrier” as defined herein is a major component of the comestible which serves as a matrix, mixing-enhancer, diluent, and compatibilizer when the HFWFC is used as a component increasing fiber content in the pasta. The host/carrier can be any type of flour made from grain as long as it possesses the ability to affect homogenous mixing in the absence of added water when dry functionalized. Whole wheat flour is preferred.

The host/carrier must be capable of endogenous moisture exudation upon disruption of its structure, e.g., by mechanical mixing. Furthermore, the host/carrier must have a moisture content sufficient to hydrate itself and at least a fiber component to provide a substantially homogenous mixture.

The host/carrier should have a moisture content of at least about 10% to about 14%. In preferred embodiments, the host carrier is durum wheat or whole wheat. In the case of durum wheat, the moisture content is preferably from about 12% to about 14%. In the case of whole wheat, the moisture content is preferably about 10% to about 13%.

Methods of determining the moisture content of flour are known in the art. As defined herein, percent moisture content is determined using the method as set forth by the International Association for Cereal Science and Technology (ICC), Standard No. 110/1. In general, the method includes a determination of the weight loss suffered by a sample when dried under fixed conditions.

Durum wheat is the hardest of all wheat. Its high protein content and gluten strength make durum wheat good for pasta and bread, but is less suitable for cakes, which are generally made from softer wheat.

Whole wheat flour is a powdery substance derived from grinding or mashing the whole grain of the wheat. The word “whole” refers to the fact that all of the wheat grain, i.e., the bran, germ and endosperm, are ground without removing any portion of the grain in the process of making the flour. The presence of the bran and germ give whole wheat flour its brown appearance. This is in contrast to “white” or processed flour which contain only the endosperm.

A “low-moisture-content fiber source” (LMFS) means a high fiber ingredient which has a low moisture content. The LMFS can include any vegetable fiber having a moisture content less than about 6% and a dietary fiber of greater than 80%.

Dietary fiber is the indigestible portion of plant foods that moves through the digestive system, absorbs water, and facilitates defecation. Dietary fiber consists of non-starch polysaccharides. Examples of such polysaccharides includes inulin, cellulose, dextrins lignin, waxes chitins, pectins, beta-glucans and oligosaccharides.

In a preferred embodiment, the LMFS is a vegetable fiber that includes inulin. Inulin is a group of oligosaccharides occurring naturally in many plants. They belong to a class of carbohydrates known as fructans. Plants that include high concentrations of inulin include elecampane, dandelion, wild yam, Jerusalem artichoke, chickory, jicama, burdock, onion, garlic, agave, and yacon. In a preferred embodiment, the inulin is derived from Jerusalem artichoke.

Inulin has unique nutritional characteristics. It ranges from completely bland to subtly sweet and can be used to replace sugar and fat. This is particularly advantageous because inulin contains a third to a quarter of the food energy of sugar or other carbohydrates and a sixth to a ninth of the food energy of fat. Inulin has a minimal impact on blood sugar levels and, in contrast to fructose, is not insulemic and does not raise triglyceride levels. These characteristics make inulin suitable for diabetics and potentially helpful in managing blood sugar-related illnesses.

Commercial sources of inulin are also available. For example, Cargill, Inc. sells Oliggo-Fiber® Inulin, which is a naturally occurring fructan extracted from chickory root. Inulin derived from Jerusalem artichoke is commercially available from Meelunie American, Inc., Farmington Hills, Mich.

Inulin is generally accepted as a soluble dietary fiber as defined the American Association of Cereal Chemists (AACC) and the Food and Nutrition Board, Institute of Medicine.

In a preferred embodiment, the LMFS is Jerusalem artichoke having a moisture content of about 5% and a dietary fiber (inulin) content of between about 85-90%, preferably at least about 85%.

“Semi-sequentially dry combining” (SSDC) means adding the LMFS to the host/carrier in the absence of added water. SSDC further means that the LMFS is added to the host/carrier simultaneously with onset of functionalization or after functionalization, i.e., exudation of endogenous moisture from the host/carrier, has begun. In a preferred embodiment, SSDC of the LMFS with the host/carrier occurs after functionalization of the host/carrier has been started.

The SSDC step includes adding the LMFS in an amount such that a substantially homogenous mixture is achieved with the host/carrier. The amount of LMFS added in relation to the HFWFC is approximately between 4 wt % and 16 wt % of the HFWFC, preferably between 5 wt % and 12 wt % of the HFWFC, more preferably between 6 wt % and 10 wt % of the HFWFC. In a preferred embodiment, the LMFS is inulin derived from Jerusalem artichoke added in an amount of about 7.5 wt % of the HFWFC.

The method of the invention further includes dry blending at least one grain-based binder and a grain-based texturizer into the homogeneous mixture formed by the host/carrier and LMFS to form a partially reconstituted high fiber wheat flour component (HFWFC). “Dry-blending” as defined herein means further mixing at least one, and preferably more than one, grain-based binder in the absence of added water.

The grain-based binder and grain-based texturizer each have a moisture content greater than that of the LMFS. In addition, the grain-based binder and grain-based texturizer preferably each have a moisture content less than that of the host/carrier. “Grain-based” as used herein means that the component is derived from grain, i.e., the grass fruit. In a preferred embodiment, the at least one grain-based binder is selected from the group consisting of wheat protein, wheat gluten, or a combination thereof.

The term “wheat protein” as used herein generally refers to wheat protein isolates derived from wheat gluten. Wheat protein isolates are generally derived from wheat gluten by taking advantage of gluten's solubility at alkaline or acidic pH values. Wheat gluten exhibits a classical “U-shaped” solubility curve with a minimum solubility or isoelectric point at pH 6.5-7.0. The gluten can be solubilized, and the wheat proteins can be separated from non-protein components by processes like filtration, centrifugation, or membrane processing followed by spray drying. Alternatively, wheat protein can be obtained by wet processing of wheat flour. The wheat flour can be repeatedly kneaded, water washed, and dewatered to remove contaminating starch and other non-protein components, and subsequently flash dried. These techniques yield a wheat protein isolate product with elevated protein content, at least about 85% by weight, more preferably at least about 90% by weight (on an N×6.25, dry basis). Wheat protein isolates are less elastic but more extensible than wheat gluten. Examples of preferred wheat protein isolates include ARISE 3000, ARISE 5000, and ARISE 6000 available from MGP Ingredients, Inc., Atchison, Kans.

As used herein, “wheat gluten” is a binary mixture of gliadin and glutenin derived from the endosperm of wheat grain. These components can be separated by alcohol fractionation or by using a non-alcoholic process (as disclosed in U.S. Pat. No. 5,610,277) employing the use of organic acids. Gliadin is soluble in 60-70% alcohol and comprises monomeric proteins with molecular weights ranging from 30,000 to 50,000 daltons. These proteins are classified as alpha-, beta-, gamma-, and omega-gliadins depending on their mobility during electrophoresis at low pH. Gliadin is primarily responsible for the elastic properties of wheat gluten. Glutenin is the alcohol insoluble fraction and contributes primarily to the elastic or rubbery properties of wheat gluten. Glutenin is a polymeric protein stabilized with inter-chain disulfide bonds and made up of high-molecular weight and low molecular weight subunits. Generally, glutenin exhibits a molecular weight exceeding one million daltons. Preferred fractionated wheat protein products comprise at least about 85% by weight protein, and more preferably at least about 90% by weight for gliadin and about 75% by weight protein, and more preferably at least about 80% by weight for glutenin, all proteins expressed on N×6.25, dry basis. Wheat gluten is commercially available from Meelunie BV, Amsterdam, Holland.

If there is a plurality of binders added to the homogenous mixture of host/carrier and LMFS, it is preferred that the grain-based binders be added to the homogeneous mixture stepwise, starting with the binder having the lowest moisture content and then adding the binder having the next highest moisture content. Each flour based binder should be fully mixed into the homogeneous mixture formed by the host/carrier and LMFS before adding the next binder.

Preferably, the wheat protein has a moisture content of about 7%, a protein content of about 80-85%, and a dietary fiber content of about 0.01-0.02%. Preferably, the wheat gluten has a moisture content of about 7%, a protein content of about 70-75%, and a dietary fiber of about 0.01-0.02%.

The amount of dietary fiber is measured by ICC Standard No. 156. The amount of crude protein is measured by ICC Standard No. 105/2.

The amount of grain-based binder can vary based upon the nutritional profile and organoleptic characteristics desired in the high fiber pasta. A higher amount of wheat protein may be desired, for example, to impart a chewiness to the product.

In a preferred embodiment, the at least one flour-based nutrient binder includes wheat protein added in an amount of about 3 wt % to 12 wt % of the HFWFC. In another preferred embodiment, the at least one grain-based binder includes wheat gluten added in an amount of about 3 wt % to 12 wt % of the HFWFC.

The texturizer is a grain-based product that provides a desired feel in the mouth when eating. For example, the texturizer can be a wheat product that provides a softness to the pasta. In a preferred embodiment, the grain-based texturizer is wheat starch, preferably modified wheat starch.

As used herein, the term “wheat starch” refers to a composition comprised of straight chain amylose and branched chain amylopectin isolated from wheat flour. Wheat starch is a byproduct when gluten, derived from wheat protein, is made. Wheat starch may be produced from wheat by various methods, all of which include crushing the plant material, washing the starch free from the protein, cellulose and other substances, further concentrating the starch composition, and subsequently drying and grinding the composition.

In a preferred embodiment, the wheat starch is a modified wheat starch. “Modified” means the wheat starch has been altered either chemically or physically. The modified wheat starch can also be another source of fiber. Modified wheat starch is commercially available. For example, modified wheat starch is described in U.S. Pat. No. 5,855,946 (incorporated herein by reference) and is sold under the name Fibersym® RW by MGP Ingredients, Inc., Atchison, Kans. The Fibersym® RW wheat starch has a low water-holding capacity which provides a smooth texture and has a neutral flavor.

It is also preferred that the texturizer have a moisture content greater than that of binder. For example, the texturizer can be modified wheat starch having a moisture content of about 10%, a protein content of about 0.05%, and a dietary fiber content of about 65-66%. If the texturizer, e.g., modified wheat starch, has a moisture content greater than that of the binder, it is preferred that the binder or plurality of binders be dry blended into the homogenous mixture before the texturizer. In this way, both the binder(s) and texturizer would be dry blended in an order of increasing moisture content.

In another preferred embodiment, the texturizer includes modified wheat starch added in an amount of about 20 wt % to about 50 wt %, more preferably about 30 wt % to about 40 wt %, of the HFWFC. Modified wheat starch is particularly favorable for providing a softness to the pasta made with the HFWFC.

In a preferred embodiment, the binder includes wheat protein or wheat gluten added in an amount of from about 3 wt % to about 12 wt % by weight of said HFWFC, and the texturizer includes modified wheat starch added in an amount of from about 20 wt % to about 50 wt % by weight of said HFWFC.

Additional ingredients can be added to the HFWFC before being processed into the pasta. Such additional ingredients can include additional flour-based and non-flour-based ingredients.

The present invention also includes in a preferred embodiment the step of subjecting the HFWFC to a sifting process in order to regularize the particle size of the dry mixture. The dry sifted HFWFC will contain substantially uniform, i.e., “reguarlized” particles. “Sifting” means to pass the dry mixture through a sieve so as to break up and/or remove coarse or lumped particles from fine particles. Preferably, the sieve screen size is from about 30 to about 35 U.S. mesh.

The formation of the HFWFC as a “dry mixture” means that no liquid has been added to the components of the HFWFC. The moisture present in the dry HFWFC is from the endogenous moisture of the components.

The sifting process can be accomplished by, for example, moving the substantially dry mixture into a high speed sifter which will uniformly sift the entire dry mixture utilizing an air flow system that extracts the finished sifted product by vacuum.

In a preferred embodiment, the sifted dry mixture is withdrawn to an agglomerizer, such as a centrifuge air mixer, which will allow the particles to bind based on the binding power of the moisture exuded from the dry ingredients to provide particle aggregates of substantially uniform size and flow characteristics.

Furthermore, in a preferred embodiment, a flavor can be added during the sifting process. Such flavors include, but are not limited to, garlic, parsley, dehydrated dry flavors and/or texture enhancers such as rye, flax powder or any type of ingredient additive. These flavor/texture enhancers are added such that they will be sifted with the dry HFWFC to ensure uniformity of size and blend with the resulting HFWFC.

Once the HFWFC is formed, additional ingredients can be added to the HFWFC to form the all natural high fiber pasta. Without being bound by theory, it is believed that the HFWFC is acting as a reconstructed replacement for a portion of the normally derived wheat flour used in pasta products. By reconstructing the HFWFC by utilizing different parts dry blended together, i.e., host/carrier, LMFS, binder, and texturizer, the HFWFC is able to incorporate a higher amount of fiber than would be possible with conventional methods of adding fiber when formulating the pasta dough.

In a preferred embodiment, the HFWFC is pre-mixed with a pasta flour. The pasta flour can be any flour conventionally used in pasta, for example, durum wheat, whole wheat, semolina, spelt (a hexaploid species of wheat), rice flour or other gluten-free flour. In a preferred embodiment, the pasta flour is a durum wheat pasta flour. The pasta flour has a moisture content greater than that of the HFWFC. When mixing the HFWFC with the pasta flour, the net moisture of the mixture is reduced to a level less than that of the pasta flour.

Preferably, liquid can be added after the HFWFC and pasta flour have been pre-mixed. Alternatively, the liquid can be added to the HFWFC concurrently with the pasta flour. The liquid can include those conventionally used in pasta, for example, water, whole eggs, egg whites, egg yolks, etc.

In a preferred embodiment, the amount of liquid added is an amount that is absorbed by the combination of dry pasta flour and HFWFC, so that the resulting mixture forms a coarse granular structure. For example, the amount of water added can be from about 22 to about 30 wt %, preferably from about 24 to about 27 wt %, of the combination of dry pasta flour and HFWFC. The resulting dough should hold together when lightly squeezed in the hand, but not be as wet as conventional doughs that form a wet, elastic structure.

The inventor has discovered that in blending the ingredients to form high fiber pasta, durum wheat can be used instead of semolina. This allows the HFWFC, pasta flour and other ingredients to be blended using cold water. Warm water is necessary to blend semolina flour into the pasta dough. The use of cold water produces a pasta with improved taste, mouthfeel and nutrient profile compared to conventional high fiber pasta products. Without being bound by theory, it is believed that the improved properties exist because the cold water causes less of the starch in the dough to be dissolved than would otherwise be obtained using hot water.

After the dough is formed, it can be processed to form an all natural high fiber pasta. Processing can include any of the steps conventionally performed on pasta dough to form a pasta. Pasta includes, for example, spaghetti, macaroni, noodles, ziti, etc.

The pasta dough can be processed by any known means. For example, the pasta dough can be extruded into the desired shape. Alternatively, the dough can be laminated by using rollers to thin the dough and then cut into the desired length and shape. Lamination is preferred.

In addition, the pasta can be packaged “fresh” or it can be dried before packaging. In a preferred embodiment, the pasta is dried. The drying can occur by conventional means. For example, evaporation can occur through conventional mechanical dryers. The drying time can be a total of about 6 hrs. with a temperature ranging from about 105° F. to about 125° F.

The drying can occur using a multistep evaporation process. At each step, the time and temperature can vary. For example, the drying time can include four levels at a temperature of about 125° F., 117° F., 108° F. and 105° F., respectively for 1 hr and 30 min at each stage for a total of 6 hrs. At the end of the drying process, the pasta preferably has a moisture content similar to that of natural wheat, i.e., about 10.5 to about 13%.

### EXAMPLES

Provided herein are examples of pasta products which can be made using the present invention. The invention is not to be limited, however, to the examples set forth herein.

### Example 1

In this example, a partially reconstituted HFWFC was prepared in accordance with the invention. The HFWFC was manufactured using stone ground whole wheat as the host/carrier. Vegetable fiber in the form of Jerusalem artichoke was the low-moisture content fiber source (LMFS). Wheat protein was added as a grain-based binder having a moisture content greater than that of the LMFS. Modified wheat starch was added as a texturizer and an additional fiber source.

The HFWFC was formed by placing 50 lbs of stone ground whole wheat (Bemis Co., Inc., Crossett, Ark.) in a ribbon mixer container (Charles Ross & Sons, Hauppauge, N.Y.) having a 150 lb. capacity. The whole wheat had a moisture content of 11.5% and a dietary fiber content of 0.5-0.7%. 7.5 lbs of vegetable fiber in the form of inulin derived from Jerusalem artichoke (Meelunie American Inc., Farmington Hills, Mich.) were then added to the mixer. The vegetable fiber had a moisture content of about 5.0% and a dietary fiber content of 85-90%.

The ribbon mixer was run from 4-6 minutes at 17.5 rpm to blend the vegetable fiber and whole wheat based flour host/carrier. 10 lbs of wheat protein (MGP Ingredients, Inc., Atchison, Kans.) was then added to the mixer. The wheat protein had a moisture content of about 7.0% and a dietary fiber content of 0.01-0.02%. The ingredients were then mixed for an additional 4-6 minutes until fully blended. 45 lbs. of modified wheat starch (Fibersym® RW, MGP Ingredients, Inc.) was then added. The modified wheat starch had a moisture content of about 10% and a dietary fiber content of 65-66%. The ingredients were then blended for approximately 30 minutes until all ingredients were uniformly blended without coagulation of the product.

Mixing times can vary based on the humidity conditions and the amount of blend that is being prepared.

The HFWFC was then auguered into a high speed sifter that uniformly sifted the entire HFWFC utilizing of an air flow system that extracts the finished sifted product into a centrifuge air mixer. This permits the particles to bind and properly blend to provide uniformity. The finished product was bagged into 50 lb bags using the air flow system.

The nutritional analysis of the HFWFC is set forth below for a serving size of 100 grams:

| | | ANALYTICAL | ANALYTICAL | ROUNDED | % |
|---|---|---|---|---|---|
| | | DATA PER | DATA PER | DATA PER | DAILY |
| | | 100 g | SERVING | SERVING | VALUE |
| LABEL | | | | | |
| ANALYTES | | | | | |
| Calories | | 359.7 | 359.7 | 360 | |
| Calories from Fat | | 13.6 | 13.6 | 15 | |
| Total Fat | (g) | 1.51 | 1.51 | 1.5 | 2 |
| Saturated Fat | (g) | 0.33 | 0.33 | 0 | 0 |
| Trans Fat | (g) | <0.10 | <0.10 | 0 | |
| Cholesterol | (mg) | <1.0 | <1.0 | 0 | 0 |
| Sodium | (mg) | 212 | 212 | 210 | 9 |
| Total | (g) | 71.9 | 71.9 | 72 | 24 |
| Carbohydrate | | | | | |
| Dietary Fiber | (g) | 35.50 | 35.50 | 36 | 144 |
| Sugars | (g) | 2.33 | 2.33 | 2 | |
| Protein (F-6.25) | (g) | 14.63 | 14.63 | 15 | |
| Vitamin A | (IU) | <5 | <5 | | * |
| Vitamin C | (mg) | N/A | N/A | | N/A |
| Calcium | (mg) | 31.7 | 31.7 | | 4 |
| Iron | (mg) | 2.1 | 2.1 | | 10 |
| CONTRIBUTING | | | | | |
| ANALYTES | | | | | |
| Moisture | (g) | 10.34 | 10.34 | | |
| Ash | (g) | 1.58 | 1.58 | | |
| Beta Carotene | (IU) | <5 | <5 | | |
| Retinol | (IU) | <5 | <5 | | |
| Vit A % Beta | | * | | | |
| Carotene | | | | | |

*Contains Less than 2% of the Daily Value of this nutrient.

As can be seen from the results above, the 100 gram serving of HFWFC includes 144% of the daily value of dietary fiber.

### Example 2

The partially reconstituted HFWFC from Example 1 was used to make a pasta high in dietary fiber. One part of the HFWFC (45 lbs.) was sifted together with 2.5 parts (112.5 lbs.) of durum wheat based pasta flour (Cerces Harvest, St. Paul, Minn.) to form a fiber enriched pasta flour.

The HFWFC had a dietary fiber content of 36 grams per 2 ounces of HFWFC. The pasta flour had a dietary fiber content of 0.0150-0.02 grams per 2 ounces of pasta flour.

Water in an amount of 27% by weight of the combination of the HFWFC and the pasta flour was added to the mixture. The resulting dough was mixed with a high speed mixer (Nuova Supra, Italy) until the liquid was fully incorporated forming a granular dough that was still essentially dry. The dough was then laminated or extruded and dried stepwise at about 125° F., 117° F., 108° F. and 105° F., respectively for 1 hr and 30 min at each stage for a total of 6 hrs.

The resulting pasta has a dietary fiber content of 12 grams and a protein content of 7 grams per 2 ounce serving. The nutritional analysis of the high fiber pasta is set forth below for a serving size of 57 grams (2 ounces):

| | | ANA- | ANA- | ROUND- | |
|---|---|---|---|---|---|
| | | LYTICAL | LYTICAL | ED | |
| | | DATA | DATA | DATA | % |
| | | PER | PER | PER | DAILY |
| | | 100 g | SERVING | SERVING | VALUE |
| LABEL | | | | | |
| ANALYTES | | | | | |
| Calories | | 358.2 | 203.1 | 200 | |
| Calories from Fat | | 16.3 | 9.2 | 10 | |
| Total Fat | (g) | 1.82 | 1.03 | 1.0 | 2 |
| Saturated Fat | (g) | 0.47 | 0.27 | 0 | 0 |
| Trans Fat | (g) | <0.10 | <0.06 | 0 | |
| Cholesterol | (mg) | 31.9 | 18.1 | 20 | 7 |
| Sodium | (mg) | 64.3 | 36.5 | 35 | 1 |
| Total | (g) | 72.6 | 41.2 | 41 | 14 |
| Carbohydrate | | | | | |
| Dietary Fiber | (g) | 20.76 | 11.77 | 12 | 48 |
| Sugars | (g) | 6.30 | 3.57 | 4 | |
| Protein (F-6.25) | (g) | 12.85 | 7.29 | 7 | |
| Vitamin A | (IU) | 24 | 14 | | * |
| Vitamin C | (mg) | <1.0 | <0.6 | | * |
| Calcium | (mg) | 53.3 | 30.2 | | 4 |
| Iron | (mg) | 6.4 | 3.6 | | 20 |
| CON- | | | | | |
| TRIBUTING | | | | | |
| ANALYTES | | | | | |
| Moisture | (g) | 11.65 | 6.61 | | |
| Ash | (g) | 1.09 | 0.62 | | |
| Beta Carotene | (IU) | <5 | <3 | | |
| Retinol | (IU) | 24 | 14 | | |
| Vit A % Beta | | * | | | |
| Carotene | | | | | |

SUGAR PROFILE

| | | | | | |
|---|---|---|---|---|---|
| Fructose | <0.10 | (g/100 g) | Glucose | 0.62 | (g/100 g) |
| Lactose | <0.10 | (g/100 g) | Maltose | 5.30 | (g/100 g) |
| Sucrose | 0.38 | (g/100 g) | | | |

*Contains Less than 2% of the Daily Value of this nutrient.

When cooked and eaten, the pasta provided an al dente mouthfeel and a pleasant taste, without the graininess typically present in high fiber pastas.

Thus, while there have been described above what are presently believed to be the preferred embodiments of the invention, those skilled in the art will understand that other and further embodiments may be made in accordance with the true spirit of the invention and it is intended to include such other embodiments as fall within the scope of the invention as pointed out in the appended claims.

What is claimed is:

1. A method of preparing an all natural high fiber pasta comprising:
a) dry functionalizing a flour-based host/carrier to exude endogenous moisture,
b) semi-sequentially dry combining (SSDC) a low-moisture-content fiber source (LMFS) with said host/carrier in an amount which provides a substantially homogenous mixture throughout said host/carrier,
c) dry blending at least one grain-based binder and a grain-based texturizer into said homogeneous mixture to form a partially reconstituted high fiber wheat flour component (HFWFC), said grain-based binder and grain-based texturizer each having a moisture content greater than that of said LMFS, and
d) mixing the HFWFC resulting from steps a) through c) with suitable pasta flour and a liquid to form a dough.

2. A method according to claim 1, wherein said pasta flour is mixed with said HFWFC before adding said liquid.

3. A method according to claim 1, further comprising processing said dough to form said high fiber pasta.

4. A method according to claim 1 further comprising:
sifting the HFWFC resulting from steps a) through c) to regularize particle size of said HFWFC.

5. A method according to claim 4, further comprising:
agglomerizing said sifted HFWFC to provide particle aggregates of substantially uniform size and flow characteristics.

6. A method according to claim 4, further comprising adding flavors to said HFWFC during said sifting step.

7. A method according to claim 1, wherein the moisture content of said grain-based texturizer is greater than that of said binder.

8. A method according to claim 7, wherein the moisture content of said grain-based texturizer is less than that of said host/carrier.

9. A method according to claim 1, wherein said texturizer comprises modified wheat starch added in an amount of about 20 wt % to about 50 wt % of said HFWFC.

10. A method according to claim 1, wherein said host/carrier is a wheat-based flour having a moisture content of from about 10% to about 14%.

11. A method according to claim 10, wherein said wheat-based flour is whole wheat.

12. A method according to claim 11, wherein said whole wheat flour has a moisture content of from about 10% to about 13%.

13. A method according to claim 1, wherein said LMFS is a vegetable fiber having a moisture content of less than about 6% and a dietary fiber content of greater than about 80%.

14. A method according to claim 13, wherein said vegetable fiber has a moisture content of about 5% and a dietary fiber content of at least about 85%.

15. A method according to claim 1, wherein said LMFS is a vegetable fiber comprising inulin.

16. A method according to claim 15, wherein said vegetable fiber is derived from Jerusalem artichoke.

17. A method according to claim 1, wherein said LMFS is added in an amount of from about 4 wt % to about 16 wt % of said HFWFC.

18. A method according to claim 17, wherein said LMFS is inulin derived from Jerusalem artichoke in an amount of about 7.5 wt % of said HFWFC.

19. A method according to claim 1, wherein said at least one grain-based binder is selected from the group consisting of wheat protein, wheat gluten, and a combination thereof.

20. A method according to claim 19, wherein said at least one grain-based binder comprises wheat protein added in an amount of from about 3 wt % to about 12 wt % of said HFWFC.

21. A method according to claim 19, wherein said at least one grain-based binder comprises wheat gluten added in an amount of from about 3 wt % to about 12 wt % of said HFWFC.

22. A method according to claim 1, wherein said at least one binder comprises wheat protein or wheat gluten added in an amount of from about 3 wt % to about 12 wt % of said HFWFC, and said texturizer comprises modified wheat starch added in an amount of from about 20 wt % to about 50 wt % of said HFWFC.

23. A method according to claim 1, wherein said at least one grain-based binder is a plurality of binders having a particular moisture content, and wherein said binders are added in an order of increasing moisture content.

24. A method according to claim 23, wherein said texturizer is wheat starch having a moisture content greater than that of said binders, and wherein said binders are dry mixed prior to said texturizer.

25. An all natural high fiber pasta, said pasta manufactured by a method comprising:
a) dry functionalizing a flour-based host/carrier to extract endogenous moisture,
b) semi-sequentially dry combining (SSDC) a low-moisture-content fiber source (LMFS) with said host/carrier in an amount which provides a substantially homogenous mixture throughout said host/carrier,
c) dry blending at least one grain-based binder and a grain-based texturizer into said homogeneous mixture to form a partially reconstituted high fiber wheat flour component (HFWFC), said grain-based binder and grain-based texturizer each having a moisture content greater than that of said LMFS, and
d) mixing the HFWFC resulting from steps a) through c) with suitable pasta flour and a liquid to form a dough.

26. A high fiber pasta according to claim 25, wherein said pasta flour is mixed with said HFWFC before adding said liquid.

27. A high fiber pasta according to claim 25, wherein said dough is processed to form said high fiber pasta.

28. A high fiber pasta according to claim 25, wherein said texturizer comprises modified wheat starch added in an amount of from about 20 wt % to about 50 wt % of said HFWFC.

29. A high fiber pasta according to claim 25, wherein said method of manufacture further comprises:
sifting the HFWFC resulting from steps a) through c) to regularize particle size of said HFWFC.

30. A high fiber pasta according to claim 29, wherein said method of manufacture further comprises:
agglomerizing said sifted HFWFC to provide particle aggregates of substantially uniform size and flow characteristics.

31. A high fiber pasta according to claim 29, further comprising flavors added to said HFWFC during said sifting step.

32. A high fiber pasta comprising a partially reconstituted high fiber wheat flour component (HFWFC), said HFWFC manufactured by the steps of:
a) dry functionalizing a flour-based host/carrier to exude endogenous moisture,
b) semi-sequentially dry combining (SSDC) a low-moisture-content fiber source (LMFS) with said host/carrier in an amount which provides a substantially homogenous mixture throughout said host/carrier, and
c) dry blending at least one grain-based binder and a grain-based texturizer into said homogeneous mixture to form said HFWFC, said grain-based binder and grain-based texturizer having a moisture content greater than that of said LMFS.

33. A high fiber pasta according to claim 32, further comprising:
sifting the HFWFC resulting from steps a) through c) to regularize particles size of said HFWFC.

34. A high fiber pasta according to claim 33, further comprising:
agglomerizing said sifted HFWFC based on a binding characteristic of said moisture exudate of said dry ingredients to provide particle aggregates of substantially uniform size and flow characteristics.

35. A high fiber pasta according to claim 33, further comprising flavors added to said HFWFC during said sifting step.

36. A high fiber pasta comprising:
a) a partially reconstituted high fiber wheat flour component (HFWFC), said HFWFC comprising:
i) a flour-based host/carrier, wherein said host/carrier has been functionalized to exude endogenous moisture,
ii) a low-moisture-content fiber source (LMFS) that has been semi-sequentially dry combined (SSDC) with said host/carrier in an amount which provides a substantially homogenous mixture throughout said host/carrier, and
iii) at least one grain-based binder and a grain-based texturizer that have been dry blended into said homogeneous mixture to form a partially reconstituted high fiber wheat flour component (HFWFC), said grain-based binder and grain-based texturizer having a moisture content greater than that of said LMFS,
b) pasta flour, and
c) a liquid.

37. A high fiber pasta according to claim 36, wherein the moisture content of said grain-based texturizer is greater than that of said binder.

38. A high fiber pasta according to claim 37, wherein the moisture content of said grain-based texturizer is less than that of said host/carrier.

39. A high fiber pasta according to claim 36, wherein said texturizer comprises modified wheat starch added in an amount of about 20 wt % to about 50 wt % of said HFWFC.

40. A high fiber pasta according to claim 36, wherein said host/carrier is a wheat-based flour having a moisture content of from about 10% to about 14%.

41. A high fiber pasta according to claim 40, wherein said wheat-based flour is whole wheat.

42. A high fiber pasta according to claim 40, wherein said whole wheat flour has a moisture content of from about 10% to about 13%.

43. A high fiber pasta according to claim 36, wherein said LMFS is a vegetable fiber having a moisture content of less than about 6% and a dietary fiber content of greater than about 80%.

44. A high fiber pasta according to claim 43, wherein said vegetable fiber has a moisture content of about 5% and a dietary fiber content of at least about 85%.

45. A high fiber pasta according to claim 36, wherein said LMFS is a vegetable fiber comprising inulin.

46. A high fiber pasta according to claim 45, wherein said vegetable fiber is derived from Jerusalem artichoke.

47. A high fiber pasta according to claim 36, wherein said LMFS is added in an amount of from about 4 wt % to about 16 wt % of said HFWFC.

48. A high fiber pasta according to claim 47, wherein said LMFS is inulin derived from Jerusalem artichoke in an amount of about 7.5 wt % of said HFWFC.

49. A high fiber pasta according to claim 36, wherein said at least one grain-based binder is selected from the group consisting of wheat protein, wheat gluten, and a combination thereof.

50. A high fiber pasta according to claim 49, wherein said at least one grain-based binder comprises wheat protein added in an amount of from about 3 wt % to about 12 wt % of said HFWFC.

51. A high fiber pasta according to claim 49, wherein said at least one grain-based binder comprises wheat gluten added in an amount of from about 3 wt % to about 12 wt % of said HFWFC.

52. A high fiber pasta according to claim 36, wherein said at least one binder comprises wheat protein or wheat gluten added in an amount of from about 3 wt % to about 12 wt % of said HFWFC, and said texturizer comprises modified wheat starch added in an amount of from about 20 wt % to about 50% of said HFWFC.

53. A high fiber pasta according to claim 36, wherein said at least one grain-based binder is a plurality of binders having a particular moisture content, and wherein said binders are added in an order of increasing moisture content.

54. A high fiber pasta according to claim 53, wherein said texturizer is wheat starch having a moisture content greater than that of said binders, and wherein said binders are dry mixed prior to said texturizer.
